(19) United States
(12) Patent Application Publication
(10) Pub. No.: US 2026/0327979 A1
(43) Pub. Date: Oct. 22, 2026

(54) BUILDING PANEL

(71) Applicant: Dow Global Technologies LLC, Midland, MI (US)

(72) Inventors: Jinfei Wang, Shanghai (CN); Wenke Miao, Shanghai (CN); Tingting Chen, Shanghai (CN); Shijie Ren, Shanghai (CN); Xiang Geng, Shanghai (CN); Xiaomei Song, Shanghai (CN); Yabin Sun, Shanghai (CN); Guihong Liao, Shanghai (CN)

(21) Appl. No.: 19/110,581

(22) PCT Filed: Nov. 29, 2022
(86) PCT No.: PCT/CN2022/135086

§ 371 Date: Mar. 11, 2025

(51) Int. Cl. E04C 2/28; B32B 15/09; B32B 15/18; B32B 27/30

(52) U.S. Cl. CPC E04C 2/28; B32B 15/09; B32B 15/18; B32B 27/304; B32B 27/306; B32B 2250/03; B32B 2264/1021; B32B 2264/1023; B32B 2264/202; B32B 2264/303; B32B 2307/54; B32B 2307/7376; B32B 2311/30; B32B 2607/00

(57) ABSTRACT

A multi-layer building panel article including: (A) at least one layer of a polyvinylchloride material; (B) at least one tie layer of a composition including: (Bi) at least one ethylene-acrylate copolymer resin; (Bii) at least one tackifier; and (Biii) at least one inorganic filler material; and (C) at least one layer of a metal substrate; and a process for manufacturing the above multi-layer building panel article.

### FIELD

The present invention is related to a multi-layer building panel article; and more specifically, the present invention is related to a multi-layer building panel article having at least three layers, wherein at least one of the layers is at least one tie layer that effectively bonds to at least one layer of a polyvinylchloride material and at least one layer of a metal substrate; and a process for fabricating the multi-layer building panel article.

### BACKGROUND

Polyvinyl chloride (PVC) is the world's third-most widely produced synthetic plastic polymer (after polyethylene and polypropylene), due to PVC having good performance of flame-retardant, mechanical properties, anti-corrosion, heat resistance, foamability, and the like. Because of PVC's good properties, PVC has been widely used in many different applications such as building materials, flooring, artificial leather, pipe, wire and cable, non-food packaging, bottles, foam materials, sealants, and fibers. And, because of PVC's good anti-corrosion properties, PVC is a possible candidate material for the construction of anti-corrosion panels by the process of laminating PVC onto a metal using a binder to bond the PVC to the metal to form the anti-corrosion panels. Typically, an anti-corrosion panel is applied as roofing and walls for various buildings in different types of plants such as steel plants, chemical plants, breeding plants, insecticide plants, electroplate plants, and garbage power plants where the anti-corrosion property of the panel is greatly required.

As mentioned above, PVC can be laminated onto a metal substrate using a binder to bond the PVC to the metal to form an anti-corrosion panel. However, stricter environmental requirements are being promulgated by various governments related to binders because binders usually include non-environmentally friendly solvent(s). Therefore, it would be advantageous to develop a solvent-free polymer adhesive tie-layer film that has good bonding properties to PVC as well as to metal substrates (or other polar surfaces) to avoid having to use a solvent-based binder.

Heretofore, tie layers made from ethylene-based functional polymers have been widely used for bonding various materials for applications such as food packaging, infrastructure, transportation, and the like. However, using a tie layer for bonding a PVC layer to a metal is difficult because generally the adhesion is carried out by polar or secondary valence bonding instead of covalent bonding, so the bonding of PVC and metal materials together using a tie layer at high temperatures is still a challenge. Thus, using a tie layer to fabricate an anti-corrosion panel with good anti-corrosion properties in a high temperature environment is also a challenge in the industry. For example, delamination and bubbling of multilayer panels are very common issues for roofing applications due to the panels being exposed to corrosion and the sun; and thus, known anti-corrosion building panels typically have a short use life. Incumbent adhesion promoting approaches are not preferred in many applications because known adhesion approaches have a very limited effect. Various known adhesives rely on polar-polar interactions with PVC to provide bonding performance. However, the bonding performance of these known adhesives is not sufficient for high temperature (e.g., greater than 50° C.) applications.

It would be desirous to provide a solution to the problems of the prior art adhesive approaches for bonding a PVC substrate to a metal substrate by using a tie layer; and fabricating an anti-corrosion panel with good anti-corrosion properties when used in a high temperature environment.

### SUMMARY

One objective of the present invention is to develop an environmentally friendly, anti-corrosion panel for building applications. The panel structure includes, for example, at least a three-layer structure comprising at least one PVC layer, at least one tie layer, and at least one metal (such as steel) substrate layer.

In one embodiment, the novel environmentally friendly, three-layer, anti-corrosion panel structure of the present invention includes at least one tie layer disposed in between the PVC layer and the metal substrate layer to bind the PVC layer and the metal substate layer together. The tie layer provides good bonding to the PVC layer and metal layer; and the panel containing the tie layer resists delamination after the panel is subjected to 90° or 120° bending deformation tests. The tie layer used in fabricating the above three-layer panel structure of the present invention also provides good bonding to the PVC layer at high temperatures (e.g., >50° C.). Thus, the PVC layer which exhibits anti-corrosion properties will continue to provide anti-corrosion properties to the building panel, as a whole, at high temperatures such as >50° C.

Accordingly, in one general embodiment, the present invention is directed to a multi-layer building panel article including: (A) at least one layer of a polyvinylchloride material; (B) at least one tie layer of a composition including: (Bi) at least one ethylene-acrylate copolymer resin; (Bii) at least one tackifier; and (Biii) at least one inorganic filler material; and (C) at least one layer of a metal substrate.

In another embodiment, the present invention is directed to a process for fabricating the above anti-corrosion multi-layer building panel article.

### BRIEF DESCRIPTION OF THE DRAWINGS

FIG. 1 is a schematic illustration showing a cross-sectional view of a three-layer, anti-corrosion, multi-layer building panel structure of the present invention.

FIG. 2 is a schematic illustration showing a cross-sectional view of a four-layer, anti-corrosion, multi-layer building panel structure of the present invention.

FIG. 3 is a schematic illustration showing a cross-sectional view of a five-layer, anti-corrosion, multi-layer building panel structure of the present invention.

### DETAILED DESCRIPTION

As used herein, the term “composition” refers to a mixture of materials that comprises the composition, as well as reaction products and decomposition products formed from the materials of the composition.

As used herein, the term “polymer” refers to a polymeric compound prepared by polymerizing monomers (by copolymerization), whether of the same or a different type. The generic term “polymer” thus embraces: (1) the term homopolymer (employed to refer to polymers prepared by polymerizing only one type of monomer, with the understanding that trace amounts of impurities can be incorporated into the polymer structure); and (2) the term copolymer or interpolymer (employed to refer to polymers prepared by polymerizing two or more different monomers, with the understanding that trace amounts of impurities can be incorporated into the polymer structure). Trace amounts of impurities (for example, catalyst residues) may be incorporated into and/or within the polymer. A polymer may be a single polymer or a polymer blend.

The term “interpolymer” refers to polymers prepared by polymerizing at least two different types of monomers. The generic term interpolymer thus includes copolymers and other polymers prepared by polymerizing more than two different monomers.

A copolymer that is prepared by polymerizing two monomer types is referred to as a “bipolymer”.

The term “terpolymer” refers to polymers prepared by polymerizing at least three different types of monomers.

The term “quaterpolymers” refers to polymers prepared by polymerizing at least four different types of monomers.

An “acrylate polymer” (also known as acrylic or polyacrylate) is any of a group of polymers prepared from acrylate monomers.

The term “inorganic filler material” as used in the present invention refers to inorganic fillers, metal oxide compounds, and mixtures thereof.

The term “anti-corrosion” as used herein refers to the corrosion protection offered by PVC. PVC has good performance for anti-corrosion; and if PVC can be firmly bonded to metal such as steel, the steel can be protected from corrosion during exposure of the steel to weather. The tie layer of the present invention offers excellent bonding (e.g., without occurrence of delamination during heating and aging) between PVC and a steel substrate to protect the steel substrate from corrosion.

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step or procedure not specifically delineated or listed.

As used throughout this specification, the abbreviations given below have the following meanings, unless the context clearly indicates otherwise: “=” means “equal to”; “~” means “approximately”; “@” means “at”; “<” means “less than”; “>” means “greater than”; “≤” means “less than or equal to”; “≥” means “greater than or equal to”; “I₂” means “melt index”; “°” means degree(s); g=gram(s); mg=milligram(s), pts=parts by weight; kg=kilogram(s); Kg/h=kilograms per hour; g/cc=gram(s) per cubic centimeter; kg/m³=kilogram(s) per cubic meter; g/mol=gram(s) per mole; L=liter(s); mL=milliliter(s); g/L=gram(s) per liter; Mw=Mass molecular weight; Mn=number molecular weight; Mz=z-average molecular weight; m=meter(s); μm=micron(s): nm=nanometer(s); mm=millimeter(s); cm=centimeter(s); min=minute(s); s=second(s); mm/s²=millimeter(s) per second squared; mm/s=millimeter(s) per second; ms=millisecond(s); hr=hour(s); mm/min=millimeter(s) per minute; m/min=meter(s) per minute; m/s=meter(s) per second; rad/s=radian per second; ° C.=degree(s) Celsius; ° C./min=degree(s) Celsius per minute; °/s=degree(s) Celsius per second; mPa·s=millipascals-second(s); mPa=megapascal(s); MPa=Megapascal(s); kPa=kilopascal(s); Pa·s/m²=pascals-second(s) per meter squared; N=newton(s); cN=centinewton(s); N/m=newton(s) per meter; rpm=revolution(s) per minute; mm²=millimeter(s) squared; g/10 min=gram(s) per 10 minutes; J=Joule(s); J/g=Joule(s) per gram; %=percent; eq %=equivalent percent; vol %=volume percent; and wt %=weight percent.

Unless stated otherwise, all percentages, parts, ratios, and like amounts, are defined by weight. For example, all percentages stated herein are weight percentages (wt %), unless otherwise indicated.

Temperatures are in degrees Celsius (° C.), and “ambient temperature” means between 20° C. and 25° C., unless specified otherwise.

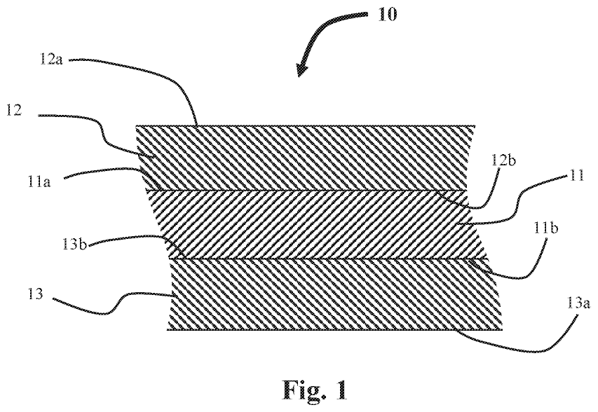

With reference to FIG. 1, there is shown a multi-layer panel structure or article, generally indicated by reference numeral 10, including a tie layer 11 having a first side 11a and a second side 11b, a PVC layer 12 having a first side 12a and a second side 12b, and a metal layer 13 such as a steel layer 13 having a first side 13a and a second side 13b. As shown in FIG. 1, multilayers are used to fabricate the building panel structure 10 by laminating individual film layer members together; wherein the tie layer 11 used in the panel structure 10 is a monolayer or single layer 11 disposed in contact with, and in between, the PVC layer 12 and the steel layer 13. One side (the first side) 11a of the monolayer tie layer 11 forms a contiguous boundary between the inner most side (the second side) 12b of the PVC layer 12 and the first side 11a of the tie layer 11. The outer first side 12a of the PVC layer 12 is open to the environment. The other side (second side opposite of the first side) 11b of the tie layer 11 forms a contiguous boundary between the inner most side (second side) 13b of the steel layer 13 and the second side 11b of the tie layer 11. The outer first side 13a of the steel layer 13 is open to the environment.

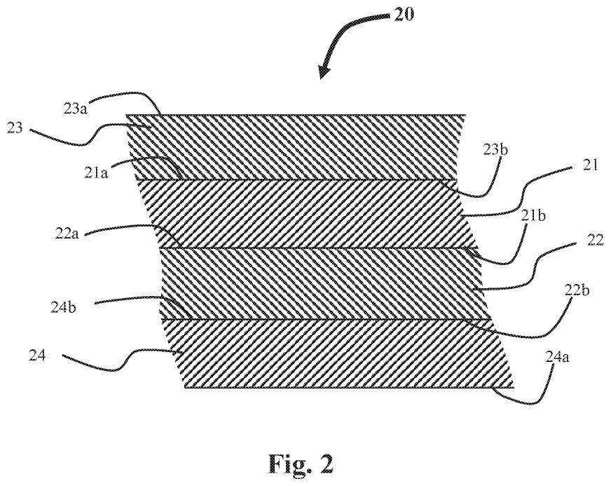

With reference to FIG. 2, there is shown a panel comprising a multilayer panel structure or article, generally indicated by reference numeral 20, including a first tie layer 21 having a first side 21a and a second side 21b; a second tie layer 22 having a first side 22a and a second side 22b; a PVC layer 23 having a first side 23a and a second side 23b; and a metal layer 24 such as a steel layer 24 having a first side 24a and a second side 24b. As shown in FIG. 2, multilayers are used to fabricate the building panel structure 20 by laminating individual film layer members together; wherein the tie layer 21 is disposed in contact with, and in between, the second tie layer 22 and the PVC layer 23 wherein one side (the first side) 21a of the tie layer 21 forms a contiguous boundary between the inner most side (the second side) 23b of the PVC layer 23 and the first side 21a of the tie layer 21. The outer first side 23a of the PVC layer 23 is open to the environment. The second tie layer 22 is disposed in contact with, and in between, the first tie layer 21 and the steel layer 24 wherein the other side (the second side opposite of the first side) 21b of the tie layer 21 forms a contiguous boundary between one side (the inner most first side) 22a of the second tie layer 22 and the second side 21b of the tie layer 21. The other side (the second side opposite of the first side) 22b of the second tie layer 22 is disposed in contact with, and in between, the second side 21b of the first tie layer 21 and the inner most side (the second side) 24b of the steel layer 24. The second side 22b of the second tie layer 22 and the inner most side 24b of the steel layer 24 forms a contiguous boundary between the second side 22b of the second tie layer 22 and the inner most side 24b of the steel layer 24. The outer first side 24a of the steel layer 24 is open to the environment.

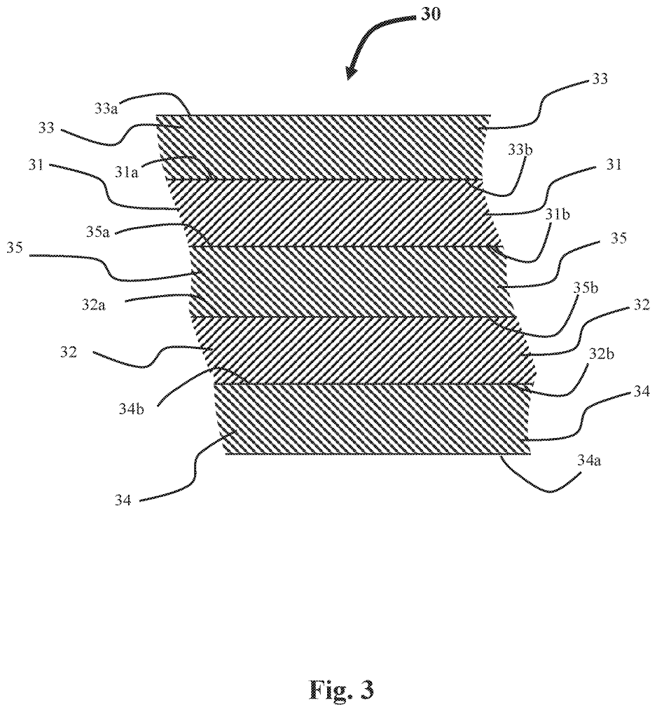

As shown in FIG. 2, in some embodiments, one or more tie layer films can be used to manufacture the building panel product or article. For example, in another embodiment, the multilayer panel structure of the panel may be a five-layer structure as shown in FIG. 3. With reference to FIG. 3, there is shown a panel comprising a five-layer panel structure or article, generally indicated by reference numeral 30, including a first tie layer 31 having a first side 31a and a second side 31b; a second tie layer 32 having a first side 32a and a second side 32b; a first PVC layer 33 having a first outer side 33a and a second inner side 33b; a second PVC layer 34 having a first outer side 34a and a second inner side 34b; and a metal core layer 35 such as a steel layer 35 having a first side 35a and a second side 35b. As shown in FIG. 3, multilayers are used to fabricate the building panel structure 30 by laminating individual film layer members together; wherein the core metal layer (or center layer) of the panel structure 30 is the metal substrate layer 35 disposed in between, and in contact with, the first tie layer 31 and the second tie layer 32.

The first tie layer 31 of the panel structure 30 is disposed in contact with, and in between, the first PVC layer 33 and the core metal layer 35. One side (the first side) 31a of the first tie layer 31 forms a contiguous boundary between the inner most side (the second side) 33b of the PVC layer 33 and the first side 31a of the first tie layer 31. The other side (the second side) 31b of the first tie layer 31 forms a contiguous boundary between one side (the first side) 35a of the core metal layer 35 and the second side 31b of the tie layer 31. The outer side 33a of the first PVC layer 33 is open to the environment.

With reference to FIG. 3 again, the second tie layer 32 is disposed in contact with, and in between, the second PVC layer 34 and the steel core layer 35. One side (the first side) 32a of the second tie layer 32 forms a contiguous boundary between the other side (the second side) 35b of the core metal layer 35 and the first side 32a of the second tie layer 32. The other side (the second side opposite of the first side) 32b of the second tie layer 32 is disposed in contact with, and in between, the second side 35b of the core steel layer 35 and the inner most side (the second side) 34b of the second PVC layer 34 and the second side 32b of the second tie layer 32. The outer side 34a of the second PVC layer 34 is open to the environment.

The first tie layer 31 in the above five-layer panel 30 is disposed in between, and in contact with, one side of the core metal layer 35 and one side of the first PVC layer 33. The second tie layer 32 in the above five-layer panel 30 is disposed in between the other side of the core metal layer 35 and one side of the second PVC layer 33. The first PVC layer 33 and the second PVC layer 34 can also be referred to outer skin layers 33 and 34, respectively.

The film structure of the five-layer building panel article such as panel 30 shown in FIG. 3, may also be referred to as an A/B/C/B′/A′ multilayer film structure; wherein each A and A′ is a first and second outer skin layer (e.g., PVC layers 33 and 34 shown in FIG. 3), respectively, of the present invention building panel article 30; each B and B′ is a first and second adhesion-promoting tie layer (e.g., tie layers 31 and 32 shown in FIG. 3), respectively, of the present invention building panel article; and C is an inner core metal layer (e.g., metal core layer 35 shown in FIG. 3). The tie-layer B is disposed in between, and in contact with, the outer layer A and the core layer C; and the other tie-layer B′ is disposed in between, and in contact with, the outer layer A′ and the core layer C. The outer layers A and A′ can be the same material or different materials. Any combination of A, A′, B, B′ and C layers is readily apparent to one skilled in the art of film making.

In other embodiments, the building panel article or product can be made from a combination of various film materials known in the art for use in the fabrication of building panels. For example, with reference to FIG. 3 again, the outer skin layers 33 and 34 (the A layer and/or the A′ layer) can be formed of PVC resin, polyvinylidene fluoride (PVDF), polypropylene (PP), and mixtures thereof. At least one of the layers 31 and/or 32 (the B layer and/or the B′ layer), as adhesion-promoting tie layers, can be formed from the tie layer composition described herein below. And, the metal layer (the C layer), as the core metal layer of the building panel structure, can be made of various substrates including metal such as steel, aluminum, aluminum alloy, stainless steel, galvanized steel sheet, and mixtures thereof; other substrates such as an aluminum composite panel, and mixtures thereof; and a combination of two or more substrates described above.

The thickness of the tie layers 31 and 32 used in fabricating the multilayer building panel article 30 of the present invention is, for example, from 10 μm to 120 μm in one embodiment, from 10 μm to 100 μm in another embodiment and from 20 μm to 60 μm in still another embodiment.

The thickness of the PVC layers 33 and 34 used in fabricating the multilayer building panel article 30 of the present invention is, for example, from 10 μm to 120 μm in one embodiment, from 10 μm to 100 μm in another embodiment and from 20 μm to 60 μm in still another embodiment.

The thickness of the metal core layer 35 used in fabricating the multilayer building panel article 30 of the present invention is, for example, from 10 μm to 120 μm in one embodiment, from 10 μm to 100 μm in another embodiment and from 20 μm to 60 μm in still another embodiment.

In general, the overall thickness of the multilayer building panel article 30 of the present invention is, for example, from 30 μm to 360 μm in one embodiment, from 30 μm to 300 μm in another embodiment and from 60 μm to 180 μm in still another embodiment.

In one broad embodiment of the present invention, a process for making the panel of the present invention includes, for example, using any conventional lamination process and equipment well known to those skilled in the art of forming panels using typical lamination fabrication parameters easily determined by those skilled in the art of producing building panel articles. For example, to construct a building panel member, the tie layer, the PVC film layer, and the steel substrate layer are laminated together at a temperature of ≥160° C. in one general embodiment and from 160° C. to 200° C. in another embodiment. The lamination can be carried out at the above-described temperature range for a time period of >2 s in one general embodiment; ≥3 s in another embodiment; and from 3 s to 15 s in still another embodiment. In other embodiments, other lamination process parameters/conditions can include, for example, pre-heating the metal layer and tie layer; and then laminating the PVC layer with the other layers together on a lamination line at a lamination line speed of, for example, from 1 m/min to 20 m/min in one general embodiment; from 4 m/min to 15 m/min in another embodiment; from 6 m/min to 12 m/min in still another embodiment; and from 8 m/min to ~10 m/min in yet another embodiment.

Reference will now be made in detail to embodiments of the tie layer film member made from a tie layer composition, component (B), including: (Bi) at least one ethylene-acrylate copolymer resin, (Bii) at least one tackifier; and (Biii) at least one inorganic filler material. The tie layer may be used in building panel member applications for bonding a PVC film layer to a steel substrate layer. However, it is noted that this is merely an exemplary illustrative implementation of the embodiments disclosed herein. The embodiments are applicable to different types of building panel structures or articles and technologies that desire incorporation of a tie layer that provides (1) good adhesion with PVC without detrimental delamination at elevated temperatures and without a deleterious effect on the mechanical and thermal properties of the panel; and (2) improved peel strength at 50° C. and higher temperatures.

The tie layer formulation or composition that can be used for fabricating a tie layer film product or member to be incorporated, as at least one layer, in the building panel article of the present invention, comprises, for example, a combination, blend or mixture of: (Bi) at least one ethylene-acrylate copolymer resin; (Bii) at least one tackifier; (Biii) at least one inorganic filler material; and (Biv) optionally, one or more additives, agents, or components, if desired.

In one preferred embodiment of the present invention, the tie layer composition includes, for example, a tie layer to bond with PVC or a building panel structure (e.g., PVC layer-tie layer-steel layer). For example, the tie layer composition, component (B), includes (Bi) from 42 wt % to 88 wt % of the at least one ethylene-acrylate copolymer resin; (Bii) from 10 wt % to 50 wt % of the at least one tackifier; (Biii) from 2 wt % to 8 wt % of the at least one inorganic filler material; and (Biv) one or more optional components in an effective concentration, if desired. The optional component(s) (Biv) can be added to, and mixed with, any one or more of the above components (Bi)-(Biii), if desired.

In some embodiments, the above composition is advantageously used to make a tie layer film product to be incorporated in the multilayer building panel article of the present invention. In one embodiment, the tie layer film product is incorporated into a multilayer panel structure for building applications wherein the tie layer film product is at least one layer of the multilayer building panel structure. In one embodiment, the at least one layer of the multilayer building panel structure is a tie layer film in direct contact with the metal substrate of the panel structure.

Prior to making a tie layer film product from the tie layer composition, the tie layer composition is first processed into pellets. For example, the components (Bi)-(Biii), and optionally (Biv), forming the blend formulation are melt blended (mixed by melting, e.g., via an extruder) to make the melt blend formulation. Then, the melt blend formulation is passed from an extruder (e.g., a twin-screw extruder) through a strand die into a pelletizer to form the pellets of the blend formulation. Once made, the pellets can be used immediately or stored for future use. To make a tie layer film product with the desired anti-corrosion properties, the pellets are first melted to form a molten feed formulation and then the molten formulation is forwarded to a film making process well known to those skilled in the art of film making such as a blown film process.

In one general embodiment of the present invention, the tie layer composition, component (B), useful for preparing the tie layer includes, for example, (Bi) at least one ethylene-acrylate copolymer resin comprising an ethylene copolymerized with one or more acrylate monomers. In some embodiments, an ethylene-acrylate copolymer resin, an ethylene-acrylate terpolymer resin, and mixtures thereof, are prepared and used as component (Bi).

Exemplary of the acrylate comonomer used for copolymerizing with ethylene to form the ethylene—acrylate copolymer/terpolymer resin, component (Bi), includes for example: vinyl acetate (VA); methyl acrylate (MA); ethyl acrylate (EA); butyl acrylate (BA); and mixtures thereof. In a preferred embodiment, the resin includes, for example: VA, MA, EA, and mixtures thereof.

In another embodiment, the at least one ethylene-acrylate copolymer/terpolymer resin, component (Bi), may optionally contain one or more functional groups selected from, but not limited to, for example, maleic anhydride; epoxy; hydroxy; carboxylic acid; carboxylate having a formula of COOM, where M is Na, K, Li, Mg, Zn, Cs, Al and mixtures thereof; and a combination of two or more of the above functional groups.

Exemplary of some commercially available ethylene-acrylate copolymer/terpolymer resins useful for preparing the tie layer composition includes for example: the series of resins available from The Dow Chemical Company under the tradenames ELVALOY™ AC and FUSABOND™; and mixtures thereof.

The ethylene-acrylate copolymer/terpolymer resin, component (Bi), used in preparing the tie layer composition, can be present in the composition in an amount, for example, of generally from 42 wt % to 88 wt % in one embodiment; from 55 wt % to 85 wt % in another embodiment; and from 70 wt % to 80 wt % in still another embodiment, based on the total amount of components in the tie layer composition.

The at least one ethylene-acrylate copolymer/terpolymer, component (Bi) of the tie layer composition, for example VA, MA, EA, BA or the mixture thereof, advantageously offer adhesion performance, such as good bonding, high peel strength, and the like.

In one general embodiment, the tie layer composition useful for preparing the tie layer includes, for example, at least one tackifier, component (Bii). The at least one tackifier, component (Bii) of the tie layer composition, for example hydrocarbon resins, C5, C9 or dicyclopentadiene, phenol and mixtures thereof are advantageously used to modify for example tack, adhesion, and cohesion.

The tackifier, component (Bii), is available in pellet form and a plurality of pellets is blended with the ethylene-acrylate copolymer/terpolymer resin, component (Bi).

Exemplary of the tackifier, component (Bii), useful for preparing the tie layer composition includes for example, at least one tackifier selected from the group consisting of an aliphatic compound having ≥C5 carbon atoms, a hydrogenated compound having ≥C5 carbon atoms, an aromatic-modified aliphatic compound having ≥C5 carbon atoms, an aromatic compound having ≥C9 carbon atoms, a hydrogenated compound having ≥C9 carbon atoms, rosin, terpene, and mixtures thereof. In a preferred embodiment, the tackifier includes, for example, a ≥C5 aliphatic compound, a ≥C5 aromatic compound and mixtures thereof.

And optionally, the resin contains functional groups selected from, but not limited to, at least one of maleic anhydride, epoxy, hydroxy, carboxylic acid, and carboxylate (COOM, where M may be selected from the group consisting of Na, K, Li, Mg, Zn, Cs, and Al); (Bii) from 10 wt % to 50 wt % of at least one tackifier, where the tackifier is at least one hydrocarbon resin compound including aliphatic compounds (e.g., an aliphatic compound having ≥C5 carbon atoms), aromatic compounds (e.g., an aromatic compound having ≥C9 carbon atoms), cyclo-aliphatic compounds (e.g., an aromatic-modified aliphatic compound having ≥C5 carbon atoms such as dicyclopentadiene (DCPD)), rosin, terpene; and mixtures thereof.

Exemplary of some commercial tackifiers, component (Bii), useful for preparing the tie layer composition includes Regalite™ resins such as Regalite™ 1125 (available from Eastman), and mixtures of one or more other resins with the above resin.

The tackifier, component (Bii), used in preparing the tie layer composition, can be present in the composition in an amount of generally from 10 wt % to 50 wt % in one embodiment; from 12 wt % to 30 wt % in another embodiment; and from 15 wt % to 25 wt % in still another embodiment, based on the total amount of components in the tie layer composition.

In some embodiments, the tackifier, component (Bii), can be selected from at least one of (a) an aliphatic compound having from C5 to C9 carbon atoms; (b) a hydrogenated compound having from C5 to C9 carbon atoms; (c) an aromatic-modified aliphatic compound having from C5 to C9 carbon atoms; (d) an aromatic compound having from C5 to C9; (e) a hydrogenated compound having from C5 to C9 carbon atoms; (f) rosin; (g) terpene; and (h) mixtures thereof.

In one general embodiment, the tie layer composition useful for preparing the tie layer film product includes, for example, at least one inert inorganic filler material, component (Biii). The unique characteristics of the inert inorganic filler material of the tie layer composition makes the selection of the filler material important in forming the tie layer composition. The type of filler material can improve the physical and mechanical properties of the composition and in turn, the film member made from the tie layer composition and ultimately the building panel article made with the film member. The various types and quantities of the filler material; and processing conditions to prepare the composition with the filler material are important factors to consider to maximize the filler material's effect on the polymer resin material. In some embodiments, the properties of the tie layer composition, particularly the anti-corrosion property, may depend on, for example, the type/composition, shape, size and size distribution, surface roughness, aspect ratio and loading/concentration of the filler material particles used in the tie layer composition.

The inert inorganic filler material, component (Biii), of the tie layer composition, can be selected from a wide range of material types. In general, the inorganic filler material may include, for example, inorganic fillers, metal oxides, ceramics, and mixtures thereof. Generally, the filler material is used in the form of particles. In some embodiments, the filler material particles used in the tie layer composition can be made, for example, of fine glass, quartz or silica. Glass fillers are usually made of crystalline silica, silicone dioxide, lithium/barium-aluminum glass, and borosilicate glass containing zinc/strontium/lithium. Ceramic fillers are made of zirconia-silica, or zirconium oxide. In a preferred embodiment, the inorganic filler material can include, for example, quartz, fused quartz, mica, clay, kaolin, wollastonite, feldspar, graphite, and mixtures thereof. The metal oxide can include, for example, silica (SiO₂), titanium dioxide (TiO₂), aluminum oxide (Al₂O₃), and mixtures thereof.

The filler material particles used in the present invention can also be classified by shape. The shape of the filler material can include, for example, irregular, fibrous or acicular, spherical, and blocks. In a preferred embodiment, the inorganic filler material particles have a spherical shape or an irregular shape depending on the mode of the filler's manufacture. In another preferred embodiment, the filler material is spherical in shape. Spherical particles are easier to incorporate into a resin composition. Exemplary of the types the inorganic filler material shapes can include spherical filler material shapes or layered clay, such as SiO₂, Al₂O₃, and mixtures thereof. The spherical fillers advantageously increase interface area to improve bonding strength and dissipate internal stress caused by bending.

Exemplary of the inorganic filler material, component (Biii), useful for preparing the tie layer composition includes for example: spherical SiO₂, Al₂O₃, bond angle Al₂O₃ having various angular distributions for the O—Al—O bond unit (e.g., a T-shaped AlO; unit and a trigonal AlO₃ unit), and mixtures thereof. In general, the O—Al—O bond angles in the T-shaped AlO₃ unit include, for example, 168.81°, 93.05°, and 99.55°, and the O—Al—O bond angles in the trigonal AlO₃ unit include, for example, 121.66°, 121.46°, and 116.40°. In a preferred embodiment, the inorganic filler material includes, for example: SiO₂, Al₂O₃, and mixtures thereof.

In other embodiments, the inorganic filler material can also be made available in pellet form and in the form of a plurality of pellets is blended with the other components such as the ethylene—acrylate copolymer/terpolymer resin, component (Bi).

Exemplary of some commercial inorganic filler material, component (Biii), useful for preparing the tie layer composition includes for example: silicon dioxide such as SHA0030 (available from Lianyungang Ruichuang New Material Technology Co., LTD), and mixtures of one or more other fillers with the above filler.

The filler material particles used in the present invention can also be classified by size. The particle size of the filler material used in fabricating the tie layer composition can be selected from various sizes including macrofills having a filler size in the range of from 1 μm to 100 μm; microfills having a filler size in the range of from 0.03 μm to 0.05 μm; hybrids of filler material having a mix of particles between 1 μm and 20 μm and sometimes smaller particles, as small as 40 nm; and nanocomposites having a filler size of less than or equal to 100 nm.

In some embodiments, the size of the filler material is, for example, from 1 μm to 20 μm in one general embodiment, from 1 μm to 15 μm in another embodiment and from 2 μm to 10 μm in still another embodiment.

The inorganic filler material, component (Biii), used in preparing the tie layer film composition, can be present in the composition in an amount sufficient to provide the tie layer composition, and in turn, the film member made from the composition, an anti-corrosion property. The filler material loading in the tie layer film composition is generally from generally from 2 wt % to 8 wt % in one embodiment; from 2.5 wt % to 7 wt % in another embodiment; and from 3 wt % to 6 wt % in still another embodiment, based on the total amount of components in the tie layer composition.

In one embodiment, the inorganic filler material can be compounded with a base resin together with tackifiers. In another embodiment, the inorganic filler material can be compounded in the form of a masterbatch. For example, the inorganic filler material can be incorporated into a masterbatch at high concentrations and the carrier resin for the masterbatch can be an ethylene-acrylate.

In another embodiment, the tie layer composition can include one or more optional components, component (Biv), selected from a wide variety of optional additives. The additives in combination with the other components of the tie layer composition may be formulated to enable performance of specific functions while maintaining the excellent benefits/properties of the composition. For example, the following additives may be blended into the formulated tie layer resin composition to form the tie layer composition including, for example, antioxidants, UV stabilizers (e.g., HALS, UV absorber, and the like); flame retardants; PVC powders; plasticizers; calcium stearate; and mixtures thereof; pigments; colorants; UV absorbers; processing aids; other fillers; compatibilizers; other resins different from component (Bi); other tackifiers different from component (Bii); other inorganic fillers or metal oxides different from component (Biii); and the like; and mixtures thereof.

The optional additive, when used in the tie layer composition, can be present in an amount generally in the range of from 0 wt % to 10 wt % in one embodiment; from 0.1 wt % to 5 wt % in another embodiment; and from 1 wt % to 3 wt % in still another embodiment, based on the total amount of components in the tie layer composition. In other embodiments the optional additive may be added to the film composition in an amount of less than 5 wt % in one general embodiment, less than 3 wt % in another embodiment, and less than 1 wt % in still another embodiment.

In one broad embodiment of the present invention, a process for making the tie layer composition includes, for example, mixing or blending components (Bi), (Bii), and (Biii), described above; and any desired optional component (Biv) as described above. Both a dry blend process and a compounding process as known to those skilled in the art of mixing polymer resins can be used. In one preferred embodiment, a compounding process is used.

In general, the dry blending process comprises the following steps:
Step (1): weigh the correct proportion of each of the tie layer composition components (Bi), (Bii), and (Biii), and optionally (Biv) described above which are provided in pellet or powder form; and
Step (2): mix all the tie layer composition components together using a mixer such as a tumble or ribbon blender or any equivalent dry blender.

In general, the compounding (or melt blending) process comprises the following steps:
Step (1): feed the tie layer composition components (Bi), (Bii), and (Biii), and optionally (Biv), at a feed rate proportional to the respective ratios;
Step (2): melt mix the components in a mixer such as a twin screw extruder or single screw extruder or a continuous mixer or a batch mixer to form a homogeneous melt;
Step (3): filter the melt composition using a melt screen changer; and
Step (4): pelletize the filtered polymer melt using, for example, an under-water pelletizer, a strand pelletizer, or hot melt cut into the final blended pellet.

In general, the components (Bi), (Bii), and (Biii), and optionally (Biv) are processed at a temperature of from 120° C. to 180° C. and at a torque of from 10 N/m to 15 N/m at 10 rpm to ~100 rpm holding at 4 min to ~7 min, in mixing equipment known to those skilled in the art of mixing equipment such as extruders, batch mixers, or continuous mixers.

Some of the advantageous/beneficial properties exhibited by the tie layer composition produced according to the aforementioned mixing or compounding processes, can include, for example: the tie layer composition can be easily produced, that is, the different components (Bi), (Bii), and (Biii), and optionally (Biv) of the tie layer composition can be dispersed easily and more evenly (uniformly or homogeneously); and the processability of the composition is improved, that is, a tie layer film product or member can be readily fabricated from easily processing the composition. When films are fabricated using the tie layer composition, the tie layer films exhibit exceptionally improved properties such as homogeneity, adhesion improvement, delamination improvement after bending and heat aging while maintaining other mechanical and thermal properties to fulfil the requirement of the target application.

In some embodiments, a tie layer film article is produced from the tie layer composition described above. The tie layer film is useful for incorporating into a multilayer building panel structure or article for building applications. The tie layer film has a combination of good properties such as a high level of bonding strength and good bonding without delamination after deformation during application of the panel structure for building structures even with sun exposure. In fabricating the multilayer building panel structure or article, the tie layer advantageously bonds very strongly to the metal substrate layer of the panel and the PVC layer; the tie layer provides sufficient bonding to prevent or minimize delamination of any one or more layers that comprises the multi-layer building panel article.

In one preferred embodiment, a blown film process, known to those skilled in the art of film making, is used to fabricate the tie layer film. The blown film process for making a blown film tie layer generally involves the steps of: (a) providing the tie layer composition in the form of, for example, pellets; (b) melting the pellets to form a molten mass for example in a heated extruder; (c) extruding the resulting molten mass using an extrusion process; and (d) processing the extrusion material through a blown film process to form a film. For example, in the blown film process a heated bubble is formed from the resulting molten mass, and then the bubble is collapsed to form a blown film. Further, the step of forming a heated bubble may include a stretching step, which orients the film.

In another embodiment, the tie layer composition may optionally be first dried by heating in a dryer to remove surface moisture. The melting step (b) of the blown film process may be carried out at a temperature range of from 120° C. to 200° C. in one embodiment, from 130° C. to 180° C. in another embodiment, and from 150° C. to 180° C. in still another embodiment. The extruding of the tie layer composition may take place though extruder dies.

In one broad embodiment, the film composition described above is used for making a film member such as a tie layer film. The tie layer film can be a monolayer (i.e., the resultant film member is fabricated as single layer without any other co-extruded film layers); or the tie layer film can be a multilayer structure (i.e., the resultant film member is fabricated with two or more same or different layers co-extruded together) wherein at least one layer is the tie layer film of the present invention. The film composition used to manufacture the tie layer film is described above.

In one embodiment, the monolayer tie layer used to bond with the metal substrate layer such as steel is the same single layer that bonds with PVC. For example, the multilayer building panel article that incorporates a monolayer tie layer can have a structure such as PVC layer-tie layer-steel layer.

Generally, the one-layer (i.e., the monolayer) film used as the tie layer in the multilayer building panel article of the present invention may include, for example, a tie layer film made from the tie layer composition resin. The monolayer film advantageously provides good bonding with steel. For the monolayer tie structure to bond with both steel and PVC, in some embodiments, it is advantageous to use a tie layer film made from the tie layer composition resin containing at least one component of a maleic anhydride grafted material. For example, the maleic anhydride grafted material can be selected from the group consisting of: a maleic anhydride (MAH) grafted polyolefin, a MAH grafted polyolefin elastomer (POE), a maleic anhydride grafted ethylene acrylate copolymer, and mixtures thereof.

The monolayer tie layer film structure and at least the first tie layer of multi-layer tie layer film structure includes, for example, a film sheet of any desired length and width; and has a thickness of, for example, from 20 μm to 100 μm in one general embodiment; from 25 μm to 90 μm in another embodiment; and from 30 μm to 80 μm in still another embodiment.

In one broad embodiment, a process for making the monolayer film member includes, for example, using any conventional film forming process such as a blown film process and any conventional film forming equipment known to those skilled in the art of forming films.

Some of the advantages of the tie layer include, for example: (1) good adhesion with PVC without delamination after: (a) oven aging (at 85° C. for 2 hr) and (b) water boiling (at 70° C. for 2 hr); and (2) improved peel strength at 50° C. More specifically, the advantageous/beneficial properties exhibited by the tie layer produced according to the above-described process, and incorporated in a multilayer building panel article, can include, for example: (1) the multilayer building panel articles of the present invention exhibit no delamination after bending a specimen of the present invention with 90° at a speed of 0.05°/s to 1.0°/s, and heat aging at 85° C.*2 hr; and (2) the multilayer building panel articles of the present invention exhibit no delamination after a multilayer building panel article specimen of the present invention is immersed in hot (e.g., 70° C.) water for 2 hr; and (3) the multilayer building panel articles of the present invention include a multilayer building panel article specimen that exhibits a peel strength of greater than a comparative article specimen that does not contain a tie layer useful in the present invention as described above. For example, an article specimen made from a comparative tie layer resin may include a pure ELVALOY™ AC resin such as pure ELVALOY™ AC1218 wherein the comparative article specimen has a peel strength of, for example, ~1.5 N/mm as measured by the test method described in ASTM D1876.

To provide delamination protection to the multi-layer building panel article of the present invention, the tie layer should exhibit the proper storage modulus property, G′, and the proper loss modulus property, G″. For example, in some embodiments, the multi-layer building panel article of the present invention includes at least one tie layer having a storage modulus property, G′, of less than 4.70 E+05 in one general embodiment; from 2.00E+05 to less than 4.70E+05 in another embodiment; and from 2.30E+05 to less than 4.70E+05 in still another embodiment. For example, in some embodiments, the multi-layer building panel article of the present invention includes at least one tie layer having a loss modulus property, G″, of greater than 1.22E+05 in one general embodiment; from greater than 1.22E+05 to 2.0E+05 in another embodiment; and from 1.22E+05 to 1.60E+05 in still another embodiment.

A parallel-plate rotational rheometer is utilized to run an oscillatory frequency sweep test to measure the G′ and G″ values of the tie layer. The characterization of the tie layer to test for the G′ and G″ values can be performed, for example, on a stress-controlled rheometer such as AR2000ex (available from TA Instruments). Stainless steel parallel-plates (e.g., 8-mm diameter) are used for a thin disk (e.g., 8-mm diameter, ~ 600 μm thick) of the polymers. In one embodiment of the above-described test, the temperature is set at 85° C., and the frequency is set as 0.1 rad/s to 100 rad/s with a strain of 2%. When G′ is <4.70E+05 and G″ is >1.22E+05, measured using the above-described test, delamination of the layers of the panel can be prevented or significantly mitigated.

In addition to a monolayer tie layer film described above, in some embodiments, the tie layer film can comprise two or more film substrates combined to form the tie layer film member. For example, the tie layer film can be made of two, three, five, seven, nine or more layers so long as at least one of the layers is a tie layer film made from the tie layer composition described above. The multilayer tie layer film substrate can also be used in the manufacture of the multilayer building panel articles of the present invention.

In some embodiments, the multi-layer tie layer film, used to bond with the metal substrate layer of the multilayer building panel article, can be constructed of two or more different tie layers. In one preferred embodiment, the multilayer tie layer film comprises a two-layer film structure including two film layers, i.e., a first tie layer film and a second tie layer film. For example, the first tie layer of the multi-layer tie layer film is used with the other second tie layer; and first and second tie layers are in contact with each other forming a contiguous boundary between the two tie layers. The first tie layer can be the same as the second tie layer; or the first tie layer can be different than the second tie layer. For example, in one embodiment, the first tie layer of the multi-layer tie layer film can be fabricated from the tie layer composition described above (e.g., the ethylene—acrylate copolymer or terpolymer resin); and the second tie layer can be fabricated from the same composition as the first tie layer or the second tie layer can be fabricated from a different composition (e.g., maleic anhydride grafted polyethylene—acrylate resin) than the first tie layer film provided the second different tie layer is compatible with the first tie layer. The layers of the multi-layer tie layer film are made using known film fabrication processes such as a blown film process or a casting film process.

The two-layer tie layer film member can be disposed in between the PVC layer and the metal substrate (e.g., steel) layer to form the multilayer building panel article structure of the present invention. In the above two-layer tie layer film member embodiment, the first tie layer can be in coterminous contact with the PVC layer; and the second tie layer can be in coterminous contact with the metal substrate layer. In another embodiment, the first tie layer can be in coterminous contact with the metal substrate layer; and the second tie layer can be in coterminous contact with the PVC layer.

The first tie layer film can be fabricated from the above-described tie layer composition.

In one general embodiment, the second layer film useful in combination with the tie layer film can be fabricated from conventional polymer resins. For example, the two-layer tie layer film member includes the first film layer made from the tie layer composition as described above; and a second layer wherein the second layer has a component of: maleic anhydride grafted polyethylene (MAH-g-PE), maleic anhydride grafted POE (MAH-g-POE), maleic anhydride grafted ethylene acrylate copolymer; or a mixture thereof.

In other embodiments, the second layer film can be made from one or more of the following exemplary resin materials: a maleic anhydride grafted polyethylene (MAH-g-PE), a maleic anhydride grafted POE (MAH-g-POE), a maleic anhydride grafted ethylene acrylate copolymer, a maleic anhydride grafted ethylene vinyl acetate copolymer, and mixtures thereof. In a preferred embodiment, the resin material for the second layer film includes, for example: MAH-g-PE/EMA and mixtures of one or more other resins with any one or more of the above-described resin.

Exemplary of some commercial resins useful for preparing the second layer film includes for example: one or more resins from the resin series available from The Dow Chemical Company under the tradenames FUSABOND™, BYNEL™, and ELVALOY™ AC; one or more resins from the resin series available from ARKEMA under the tradename EVASIN™; one or more resins from the resin series available from REPSOL under the tradenames ALCUDIA and EBANTIX; and mixtures thereof.

The second layer film structure includes, for example, a film sheet of any desired length and width; and has a thickness of, for example, from 20 μm to 100 μm in one general embodiment; from 25 μm to 90 μm in another embodiment; and from 30 μm to 80 μm in still another embodiment. The ratio of the first layer to the second layer is generally from 0:100 to 100:0 in one embodiment; from 30:70 to 70:30 in another embodiment; from 40:60 to 60:40 in still another embodiment; and from 50:50 to 50:50 in yet another embodiment.

Some of the advantageous properties exhibited by the multilayer building panel article or product fabricated using the tie layers described above include, for example, (1) the panel exhibits an advantageously high level of peel strength; and (2) the panel exhibits advantageously no delamination after bending at an angle and aging at a high temperature including hot water boiling. In addition, the panel, as a whole, exhibits an advantageously high level of corrosion resistance which can be attributed to the PVC outer layer having an anti-corrosion property which, in turn, provides corrosion protection to the metal substrate layer of the panel strongly bonded to the PVC layer via the tie layer described above. Since the tie layer provides a strong bond (e.g., a high peel strength) between the PVC layer and the metal layer, no delamination of the layers of the panel occurs; and therefore, the use life of the panel is increased when the panel is exposed to the elements or subjected to a potential corrosive environment.

The multilayer anti-corrosion building panel article of the present invention prepared as described above can be used in various applications where a panel exhibiting corrosion resistance is advantageous. For example, the anti-corrosion panel can be applied as roofing and walls for various buildings in different types of plants such as steel plants, chemical plants, breeding plants, insecticide plants, electroplate plants, and garbage power plants where anti-corrosion is greatly required.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise, stated all parts and percentages are by weight on a total weight basis.

Various terms, designations, and raw materials used in the Inventive Examples (Inv. Ex.) and the Comparative Examples (Comp. Ex.) are explained as follows:
“MI” stands for melt index.
“RT” stands for room temperature (between 20° C. and 25° C.).
“G′” stands for storage modulus.
“G″” stands for loss modulus.

### Raw Materials

The ingredients/raw materials used to prepare the tie layer composition for the building panel samples tested in the Examples are described in Table I.

TABLE I
Raw Materials for Tie Layer Composition

| Product | Brief Description of Product | Supplier |
|---|---|---|
| ELVALOY ™ AC1218 | A copolymer of ethylene and methyl | The Dow Chemical Company |
| | acrylate, with a density of 0.94 g/cm³, and | |
| | 2.0 MI (at 190 °C/2.16 kg) | |
| ELVALOY ™ AC1224 | A copolymer of ethylene and methyl | The Dow Chemical Company |
| | acrylate, with a density of 0.944 g/cm³, and | |
| | 2.0 MI (at 190 °C/2.16 kg) | |
| Regalite ™ R1125 | A hydrocarbon C9; tackifier | Eastman |
| Spherical Silica Powder | Filler | Lianyungang Rui Chuang |
| SHA-0030 (SiO₂) | | New Material Technology |
| | | Co., LTD |
| ADMAFINE ® AO-502 | Filler | Admatechs |
| (Al₂O₃) | | |
| Talc | Filler | A staple product; various |
| | | suppliers. |
| Omya OMYACARB ® | Filler | SONGHAN Plastic |
| 520 (CaCO₃) | | Technology Co. Ltd. |

### Sample Preparation

### Compounding Procedure

The tie layer composition samples for forming a panel for testing was prepared as follows:

The resins and the tackifier used in the Examples were fed into a Brabender mixer at 150° C. The rotor speed of the mixer was set at 10 rpm and the ingredients in the mixer were mixed until the resins melted. Then, inorganic fillers were charged into the chamber of the mixer and the resultant mixture was kept mixing at 80 rpm for 5 min. Thereafter, the resulting compound was taken out of the mixer, allowed to solidify, and then cut into small pieces for further use.

### Hot Press of Film Procedure

Some of the small pieces of compound prepared in the mixer as described above were placed in a hot press machine and preheated at 150° C. for 10 min. The hot press machine was vented intermittently (e.g., every 2 minutes) 8 separate times. Then, the pieces of compound were held at 150° C. and 10 MPa (pressure between upper, and lower plates of hot press machine) for another 5 min. The resultant film from the hot press was cooled to room temperature within 5 mins at 10 MPa. After cooling, the resulting film had a thickness of ~100 μm.

### Multi-Layer Sample Panel Structure Preparation

A sample panel structure prepared for the Examples can be a multilayer structure, including a steel layer, a tie layer, and a PVC layer as shown in the schematic diagram of [symbol] [symbol] 2. The sample panel can be prepared using lamination at 180° C. for 5 s. For the single tie layer embodiment shown in FIG. 1, an MAH-g-POE/PE/EMA is necessary to enable good bonding with steel.

The sample panel structure prepared for the Examples and for testing was a rectangular multilayer structure including a steel layer having a thickness of 40 μm to 70 μm; a first tie layer having a MAH-g-POE/PE/EMA component and a thickness of 15 μm to ~60 μm; a second tie layer having a MAH-g-PE/EMA component and a thickness of 15 μm to ~60 μm; and a PVC layer having a thickness of 90 μm to ~110 μm. The sample panel structure prepared for the Examples and for testing is shown in the schematic diagram of FIG. 2. The dimensions of the rectangular sample panel structure were 2 cm in width by 10 cm in height. The overall thickness of the rectangular sample panel structure was generally from 145 μm to ~300 μm.

The data generated in the Examples is based on the two tie layers (i.e., the first and second tie layers) described above and shown in FIG. 2. The first tie layer of the present invention is prepared from the tie layer composition described above and described in Table III and Table IV; and, the second tie layer used in the Examples is a blown film made from BYNEL™ 30E868. In other embodiments, the second tie layer may include products such as resins from the resin series available from The Dow Chemical Company under the tradenames FUSABOND™, ELVALOY™, and BYNEL™

### Test Methods

The general procedure for testing the multilayer test panel specimens was as follows:
Step (I): The multilayer test panel specimens were subject to bending at 90° at a speed of from 0.05°/s to 1.0°/s, and heat aging at 85° C. for 2 hr;
Step (II): The panel specimens were immersed in hot (70° C.) water for 2 hr; and
Step (III): The panel specimens were subjected to a 180-degree peel strength test method. The 180° T-Peel test was conducted on an Instron machine equipped with an environmental cabinet according to the procedure described in ASTM D1876. The test speed used was 100 mm/min. The panel specimens were heated at 50° C. and then pulled at 100 mm/min until break.

### Test Method and Evaluation Standards for Samples

TABLE II
Building Panel Article Specimen Performance

| Panel Specimen | |
|---|---|
| Test Method | Brief Description |
| Bending at 90° and | No delamination is designated as numeral “1”; delamination is |
| 85 °C for 2 hr | designated as numeral “0”. |
| Heating in boiling | No bubbling/no delamination is designated as numeral “1”; and |
| water at 70 °C for 2 hr | bubbling/delamination is designated as numeral “0”. |
| Peel strength at 50 °C | A ratio was used where the denominator was the peel strength value |
| | measured for Pure ELVALOY ™ AC1218 and the numerator was the |
| | peel strength value measured for all other panel specimens. |
| Peel strength at 25 °C | A ratio was used where the denominator was the peel strength value |
| | measured for Pure ELVALOY ™ AC1218 and the numerator was the |
| | peel strength value measured for all other panel specimens. |

### Results of Testing

### Discussion of Results

All the multilayer sample panels tested were prepared as shown in FIG. 2. The panel samples were subjected to a peel strength test at RT and at 50° C. at a 90° bending; and the 90° bending samples were heated at 85° C. to observe whether a delamination phenomenon of the sample occurred. The results of testing the panel samples are described in Table III and Table IV. Table III shows there is no delamination at 85° C. heating and hot water boiling aging of the panel samples having a tackifier content of ≥15 wt % and having a SiO₂ content of ≥2.0 wt %. The peel strength of the panel samples is also improved both at RT and 50° C. Table IV describes results obtained based on using ELVALOY AC1224 matrix resin. Table IV shows that there is no delamination of the panel samples at 85° C. heating and hot water boiling aging of the panel samples having a tackifier content of ≥15 wt % and having a SiO₂ content of ≥2.0 wt %. The peel strength of the panel samples described in Table IV is also improved both at RT and 50° C.

The G′ value described in Tables III and IV represents the tie layer's capability of storing the energy of a building panel when the building panel is subjected to a 90° bending test. The higher the G′ value, the more internal energy storage is exhibited by the panel. For example, if G′ is greater than 4.70 E+05, the internal energy storage from a 90° bending test is too high and the building panel tends to delaminate in the bending area of the panel during a heating test or a water boiling test. The G″ value described in Tables III and IV represents the internal energy dissipation capability and adhesion capability of a building panel. When G″ is high, i.e., greater than 1.22E+05, better internal energy relaxation and better adhesion of the layers of a panel can be achieved to avoid delamination of the panel.

The multilayer building panel member of present invention uses at least one tie layer made from a composition including an ethylene—acrylate copolymer resin, a tackifier, and an inorganic filler material such that a synergistic effect of the copolymer resin and tackifier with the inorganic filler material is provided by the tie layer to the building panel member. The tie layer shows an improved bonding performance at a high temperature when subjected to a bending test at 90° and shows good peel strength performance.

TABLE III
Building Panel Member Structure with Tie Layer Containing ELVALOY AC 1218

| | Comp. | Comp. | Comp. | Comp. | Comp. | Comp. | Comp. | Comp. |
|---|---|---|---|---|---|---|---|---|
| | Ex. A | Ex. B | Ex. C | Ex. D | Ex. E | Ex. F | Ex. G | Ex. H |
| | (wt %) | (wt %) | (wt %) | (wt %) | (wt %) | (wt %) | (wt %) | (wt %) |
| Tie Layer | | | | | | | | |
| Composition | | | | | | | | |
| Component | | | | | | | | |
| ELVALOY ™ | 100 | 80 | 70 | 50 | 96 | 91 | 95 | 90 |
| AC1218 | | | | | | | | |
| Regalite ™ | | 20 | 30 | 50 | | 6 | 5 | 10 |
| R1125 | | | | | | | | |
| SiO₂ | | | | | 4 | 3 | | |
| Al₂O₃ | | | | | | | | |
| Kaolin clay | | | | | | | | |
| Total, wt % | 100 | 100 | 100 | 100 | 100 | 100 | 100 | 100 |
| Building | | | | | | | | |
| Panel | | | | | | | | |
| Member | | | | | | | | |
| Properties | | | | | | | | |
| Normalized | 1.0 | 0.7 | 0.7 | | 1.0 | 1.8 | 1.0 | 0.9 |
| peel strength | | | | | | | | |
| @ RT | | | | | | | | |
| Normalized | 1.0 | 0.9 | 0.9 | | 1.0 | 1.1 | 1.0 | 0.9 |
| peel strength | | | | | | | | |
| @ 50 °C | | | | | | | | |
| (normalized | | | | | | | | |
| 100% using | | | | | | | | |
| ELVALOY ™ | | | | | | | | |
| AC1218 as | | | | | | | | |
| the control) | | | | | | | | |
| Delamination | 0 | 1 | 1 | 0 | 0 | 0 | 0 | 0 |
| after 85 °C | | | | | | | | |
| for 2 hr heat | | | | | | | | |
| aging* | | | | | | | | |
| Delamination | 0 | 1 | 1 | 0 | 0 | 0 | 0 | 0 |
| after 70 °C | | | | | | | | |
| for 2 hr water | | | | | | | | |
| boiling* | | | | | | | | |
| G′ @ 85 °C, | 6.29 | 4.86 | 2.82 | | 6.65 | 5.42 | 4.86 | 5.42 |
| 100 rad/s | E+05 | E+05 | E+05 | | E+05 | E+05 | E+05 | E+05 |
| G″ @ 85 °C, | 1.54 | 1.23 | 1.06 | | 1.55 | 1.45 | 1.37 | 1.45 |
| 100 rad/s | E+05 | E+05 | E+5 | | E+05 | E+05 | E+05 | E+05 |
| | Comp. | Comp. | Inv. | Inv. | Inv. | Inv. | Inv. | Comp. |
| | Ex. I | Ex. J | Ex. 1 | Ex. 2 | Ex. 3 | Ex. 4 | Ex. 5 | Ex. U |
| | (wt %) | (wt %) | (wt %) | (wt %) | (wt %) | (wt %) | (wt %) | (wt %) |
| Tie Layer | | | | | | | | |
| Composition | | | | | | | | |
| Component | | | | | | | | |
| ELVALOY ™ | 85 | 84 | 82 | 81 | 80 | 78 | 85 | 85 |
| AC1218 | | | | | | | | |
| Regalite ™ | 15 | 15 | 15 | 15 | 15 | 15 | 15 | 15 |
| R1125 | | | | | | | | |
| SiO₂ | | 1 | 3 | 4 | 5 | 7 | | |
| Al₂O₃ | | | | | | | 5 | |
| Kaolin clay | | | | | | | | 5 |
| Total, wt % | 100 | 100 | 100 | 100 | 100 | 100 | 105 | 105 |
| Building | | | | | | | | |
| Panel | | | | | | | | |
| Member | | | | | | | | |
| Properties | | | | | | | | |
| Normalized | 0.8 | 0.5 | 1.7 | 1.7 | 2.4 | 1.4 | 1.0 | 1.0 |
| peel strength | | | | | | | | |
| @ RT | | | | | | | | |
| Normalized | 0.9 | 0.6 | 1.3 | 1.4 | 1.5 | 1.3 | 1.2 | 1.1 |
| peel strength | | | | | | | | |
| @ 50 °C | | | | | | | | |
| (normalized | | | | | | | | |
| 100% using | | | | | | | | |
| ELVALOY ™ | | | | | | | | |
| AC1218 as | | | | | | | | |
| the control) | | | | | | | | |
| Delamination | 1 | 0 | 1 | 1 | 1 | 1 | 1 | 1 |
| after 85 °C | | | | | | | | |
| for 2 hr heat | | | | | | | | |
| aging* | | | | | | | | |
| Delamination | 0 | 0 | 1 | 1 | 1 | 1 | 1 | 0 |
| after 70 °C | | | | | | | | |
| for 2 hr water | | | | | | | | |
| boiling* | | | | | | | | |
| G′ @ 85 °C, | 5.14 | 4.86 | 4.33 | 4.46 | 4.62 | 4.70 | 4.54 | 5.51 |
| 100 rad/s | E+05 | E+05 | E+05 | E+05 | E+05 | E+05 | E+05 | E+05 |
| G″ @ 85 °C, | 1.39 | 1.22 | 1.3 | 1.3 | 1.36 | 1.36 | 1.36 | 1.21 |
| 100 rad/s | E+05 | E+05 | E+05 | E+05 | E+05 | E+05 | E+05 | E+05 |

*If delamination occurs, delamination is designated as “0”; and if no delamination occurs, no delamination is designated as “1”.

TABLE IV
Building Panel Member Structure with Tie Layer Containing ELVALOY AC 1224

| | Comp. | Comp. | Comp. | Comp. | Comp. | Comp. | Comp. | Comp. | Comp. | Inv. | Inv. | Inv. | Inv. | Comp. |
|---|---|---|---|---|---|---|---|---|---|---|---|---|---|---|
| | Ex. K | Ex. L | Ex. M | Ex. N | Ex. O | Ex. P | Ex. Q | Ex. R | Ex. S | Ex. 6 | Ex. 7 | Ex. 8 | Ex. 9 | Ex. T |
| | (wt | (wt | (wt | (wt | (wt | (wt | (wt | (wt | (wt | (wt | (wt | (wt | (wt | (wt |
| | %) | %) | %) | %) | %) | %) | %) | %) | %) | %) | %) | %) | %) | %) |
| Tie Layer | | | | | | | | | | | | | | |
| Composition | | | | | | | | | | | | | | |
| Component | | | | | | | | | | | | | | |
| ELVALOY ™ | 100 | 90 | 80 | 70 | 50 | 95 | 85 | 84 | 85 | 77 | 82 | 80 | 78 | 75 |
| AC1224 | | | | | | | | | | | | | | |
| Regalite ™ | | 10 | 20 | 30 | 50 | | 15 | 15 | 15 | 21 | 15 | 15 | 15 | 15 |
| R1125 | | | | | | | | | | | | | | |
| SiO₂ | | | | | | 5 | | 1 | | 2 | 3 | 5 | 7 | 10 |
| Talc | | | | | | | 5 | | | | | | | |
| CaCO₃ | | | | | | | | | 5 | | | | | |
| Total | 100 | 100 | 100 | 100 | 100 | 100 | 100 | 100 | 100 | 100 | 100 | 100 | 100 | 100 |
| Building | | | | | | | | | | | | | | |
| Panel | | | | | | | | | | | | | | |
| Member | | | | | | | | | | | | | | |
| Properties | | | | | | | | | | | | | | |
| Normalized peel | 1.7 | / | / | / | / | / | 0.6 | / | / | 2.2 | 1.8 | 2.0 | 1.5 | / |
| strength @ RT | | | | | | | | | | | | | | |
| Normalized peel | 1.4 | / | / | / | / | / | 0.7 | / | / | 1.2 | 1.2 | 1.3 | 1.2 | / |
| strength a | | | | | | | | | | | | | | |
| 50 °C | | | | | | | | | | | | | | |
| (normalized | | | | | | | | | | | | | | |
| 100% using | | | | | | | | | | | | | | |
| ELVALOY ™ | | | | | | | | | | | | | | |
| AC1218 as the | | | | | | | | | | | | | | |
| control) | | | | | | | | | | | | | | |
| Delamination | 0 | 0 | 0 | 0 | 0 | 0 | 0 | 0 | 0 | 1 | 1 | 1 | 1 | 0 |
| after 85 °C | | | | | | | | | | | | | | |
| for 2 hr heat | | | | | | | | | | | | | | |
| aging* | | | | | | | | | | | | | | |
| Delamination | 0 | 0 | 0 | 0 | 0 | 0 | 0 | 0 | 0 | 1 | 1 | 1 | 1 | 0 |
| after 70 °C | | | | | | | | | | | | | | |
| for 2 hr water | | | | | | | | | | | | | | |
| boiling* | | | | | | | | | | | | | | |
| G′ @ 85 °C, | 2.92 | 2.63 | 2.21 | 1.99 | 1.68 | 1.92 | 2.64 | 3.19 | 4.72 | / | 2.64 | 2.75 | 2.31 | 2.72 |
| 100 rad/s | E+05 | E+05 | E+05 | E+05 | E+05 | E+05 | E+05 | E+05 | E+05 | | E+05 | E+05 | E+05 | E+05 |
| G″ @ 85 °C, | 1.13 | 1.00 | 1.00 | 0.96 | 1.04 | 0.78 | 1.09 | 1.04 | 1.34 | / | 1.37 | 1.33 | 1.23 | 1.17 |
| 100 rad/s | E+05 | E+05 | E+05 | E+05 | E+05 | E+05 | E+05 | E+05 | E+05 | | E+05 | E+05 | E+05 | E+05 |

*If delamination occurs, delamination is designated as “0”; and if no delamination occurs, no delamination is designated as “1”.

What is claimed is:

1. A multi-layer building panel article comprising:
(A) at least one layer of a polyvinylchloride material layer;
(B) at least one tie layer of a composition including:
(Bi) at least one ethylene—acrylate copolymer resin;
(Bii) at least one tackifier; and
(Biii) at least one inorganic filler material;
wherein the at least one tie layer bonds to the at least one metal substrate layer and the at least one polyvinylchloride material layer; and wherein the at least one tie layer provides sufficient bonding to minimize delamination of any one or more layers comprising the multi-layer building panel article; and
(C) at least one layer of a metal substrate.

2. The multi-layer building panel article of claim 1, wherein the at least one tie layer is characterized as having a storage modulus property of less than 4.70E+05, and a loss modulus property of greater than 1.22E+05; and wherein the at least one tie layer provides sufficient bonding to minimize delamination at a temperature of greater than or equal to 50° C.

3. The multi-layer building panel article of claim 1, wherein the acrylate comonomer used for preparing the at least one ethylene—acrylate copolymer resin is selected from the group consisting of vinyl acrylate, methyl acrylate, ethyl acrylate, butyl acrylate, methyl 3-methoxyacrylate, and mixtures thereof.

4. The multi-layer building panel article of claim 1, wherein the at least one ethylene-acrylate copolymer resin contains functional groups selected from the group consisting of maleic anhydride, epoxy, hydroxy, carboxylic acid, and a carboxylate having the structure COOM, wherein Mis Na, K, Li, Mg, Zn, Cs, Al and mixtures thereof; and mixtures of two or more of the functional groups.

5. The multi-layer building panel article of claim 1, wherein the at least one tackifier is selected from the group consisting of at least one of aliphatic C5, hydrogenated C5, aromatic-modified aliphatic C5, aromatic C9, hydrogenated C9, rosin, terpene, and mixtures thereof.

6. The multi-layer building panel article of claim 1, wherein the at least one inorganic filler material is selected from the group consisting of silica, calcium carbonate, quartz, fused quartz, talc, mica, clay, kaolin, wollastonite, feldspar, aluminum hydroxide, graphite, aluminum oxide, and mixtures thereof.

7. The multi-layer building panel article of claim 1, wherein the at least one ethylene-acrylate copolymer resin, component (Bi), is an ethylene—acrylate bipolymer resin; an ethylene methyl acrylate-terpolymer resin, or mixtures thereof; wherein the at least one tackifier, component (Bii), is hydrogenated C9 compound; and wherein the at least one inorganic filler material, component (Biii), is spherical silica powder or spherical aluminum oxide.

8. The multi-layer building panel article of claim 7, wherein the spherical silica powder or spherical aluminum oxide particles are from 2 microns to 5 microns in diameter.

9. The multi-layer building panel article of claim 1, wherein the concentration of the at least one ethylene—acrylate copolymer resin, component (Bi), is from 42 weight percent to 88 weight percent; wherein the concentration of the at least one tackifier, component (Bii), is from 10 weight percent to 50 weight percent; and wherein the concentration of the at least one inorganic filler material, component (Biii), is from 2 weight percent to 8 weight percent.

10. The multi-layer building panel article of claim 1, wherein the thickness of the at least one layer of a polyvinylchloride material, component (A), is from 90 microns to 110 microns; wherein the thickness of the at least one tie layer, component (B), is from 15 microns to 120 microns; and wherein the thickness of the at least one layer of a metal substrate, component (C), is from 40 microns to 70 microns.

11. The multi-layer building panel article of claim 1, wherein the at least one tie layer bonds to the metal and the polyvinylchloride; wherein the at least one tie layer provides: (a) a bond strength property to the panel at room temperature; and (b) an anti-delamination property to the panel at room temperature in accordance with a 90-degree bending test; and wherein the at least one tie layer is characterized as having a storage modulus property of less than 4.70E+05, and a loss modulus property of greater than 1.22E+05.

12. The multi-layer building panel article of claim 1, wherein the article is an anti-corrosion steel panel member.

13. A process for fabricating a multilayer structure for a building panel article comprising laminating together:
(A) at least one layer of a PVC material;
(B) at least one tie layer of a composition including:
(Bi) at least one ethylene—acrylate copolymer resin;
(Bii) at least one tackifier; and
(Biii) at least one inorganic filler material;
wherein the at least one tie layer bonds to the at least one metal substrate layer and the at least one polyvinylchloride material layer; and wherein the at least one tie layer provides sufficient bonding to minimize delamination of any one or more layers comprising the multi-layer building panel article; and
(C) at least one layer of a metal substrate.

14. The process of claim 13, wherein the at least one tie layer is characterized as having a storage modulus property of less than 4.70 E+05, and a loss modulus property of greater than 1.22E+05; and wherein the at least one tie layer provides sufficient bonding to minimize delamination at a temperature of greater than or equal to 50° C.

15. The process of claim 13, wherein the lamination is carried out at a temperature of from 160° C. to 200° C.
